(19) United States
(12) Patent Application Publication
(10) Pub. No.: US 2024/0356270 A1
(43) Pub. Date: Oct. 24, 2024

(54) LAYERED COMPOSITE MATERIAL AND SYSTEM FOR APPLIANCE SUSPENSION AND ELECTRICAL CONNECTION

(71) Applicant: BOCCI DESIGN & MANUFACTURING, INC., Vancouver (CA)

(72) Inventors: Randall BISHOP, Vancouver (CA); Patrick MULCAHY, Vancouver (CA)

(73) Assignee: BOCCI DESIGN & MANUFACTURING, INC., Vancouver (CA)

(21) Appl. No.: 18/640,217

(22) Filed: Apr. 19, 2024

Related U.S. Application Data
(60) Provisional application No. 63/497,425, filed on Apr. 20, 2023.

(51) Int. Cl. H01R 13/518; F21V 23/06; H01R 12/71

(52) U.S. Cl. CPC H01R 13/518; F21V 23/06; H01R 12/716

(57) ABSTRACT

Wiring systems for class 2 or class 3 devices include a structural support defined by a first conductive layer opposite a second conductive layer with an insulating layer juxtaposed therebetween, and an electrical jack fastener that has a head of conductive material electrically insulated from a fastener portion of conductive material by an insulator insert and is insertable into the structural support at any position along the first conductive surface to engage the fastener portion with the second conductive layer and the head with the first conductive layer. The first and second conductive layers are configured to connect to a class 2 or a class 3 power supply to define a circuit, and the head of the electrical jack fastener has a first terminal configured to connect to a first wire and the fastener portion has a second terminal configured to connect to a second wire.

### RELATED APPLICATIONS

This invention claims the benefit of U.S. Provisional Application No. 63/497,425, filed Apr. 20, 2023, which is incorporated herein by reference in its entirety.

### BACKGROUND

Existing electrical interface systems for powering appliances, such as lighting systems and chandeliers, lack integration into architectural designs, detracting from the overall aesthetic and artistic appeal of electrical installations. These systems are primarily high voltage and lack flexibility in terms of electrical connection during installation and may present unsightly distractions in the form of electrical outlets, junction boxes, and other evidence of electrical connections.

As such, there is a need for a new method and system for structurally supporting while simultaneously providing the electrical power to electrical devices, such as light fixtures, especially those that use class 2 or class 3 power supplies. Moreover, there is a need for system that mitigates visual clutter within a given spatial context for class 2 and class 3 power systems, especially one that provides seamless integration with a substrate, which provides an installer flexibility in determining optimal placement of one or more light fixtures, especially a plurality of light fixtures forming a single visual effect. Also, Class 2 and class 3 power supply systems minimize the necessity for high voltage wiring (thereby reducing copper consumption) and junction boxes.

### SUMMARY

As will be described in greater detail below, the present disclosure describes various systems and methods for mounting and providing power to lighting fixtures. The present disclosure describes systems and methods that overcome the above-noted deficiencies such as providing unobtrusive and seamless integration of chandeliers, lighting systems and other electrical appliances into architectural and artistic installations.

In a first aspect, wiring systems for light fixtures or other class 2 or class 3 devices is disclosed that includes a structural support defined by a first conductive layer opposite a second conductive layer with an insulating layer juxtaposed therebetween and insulating the first conductive layer from the second conductive layer, and an electrical jack fastener that has a head of conductive material electrically insulated from a fastener portion of conductive material by an insulator insert connected to both the head and the fastener portion for movement collectively as a unit. The first and second conductive layers are configured to connect to a class 2 or a class 3 power supply to define a circuit and the insulating layer has a thickness (T). The head of the electrical jack fastener has a first terminal configured to connect to a first wire and the fastener portion has a second terminal configured to connect to a second wire. The electrical jack fastener is insertable into the structural support at any position along the first conductive surface to engage the fastener portion with the second conductive layer and the head with the first conductive layer to provide electrical power to the electrical jack fastener. The electrical jack fastener can include a first wire connected to the first terminal and a second wire connected to the second terminal, which can be parallel wires or coaxial wires. In some embodiments, the first and second wires terminate with an electric outlet configured to receive a plug of an electrical light fixture, and the system can include an electrical light fixture plugged into the plug connector.

In some embodiments, the fastener portion of the electrical jack fastener is threaded. In some embodiments, the head portion of the electrical jack fastener has a plurality of teeth protruding from a back surface thereof which are oriented to bite into the first conductive layer.

In all embodiments, the structural support can have a first adhesive layer between the insulating layer and the first conductive layer and a second adhesive layer between the insulating layer and the second conductive layer. In all embodiments, the structural support can have an insulating film or insulating tape applied to cover at least the second conductive layer and the sides of the structural support.

In one embodiment, the structural support has a second insulating layer separating the first conducting layer from a third conducting layer, and the third conducting layer is configured to connect to ground.

In another aspect, kits are disclosed herein that include a structural support defined by a first conductive layer opposite a second conductive layer with an insulating layer juxtaposed therebetween and insulating the first conductive layer from the second conductive layer, and an electrical jack fastener that has a head of conductive material electrically insulated from a fastener portion of conductive material by an insulator insert connected to both the head and the fastener portion for movement collectively as a unit. The first and second conductive layers are configured to connect to a class 2 or a class 3 power supply to define a circuit and the insulating layer has a thickness (T). The head of the electrical jack fastener has a first terminal configured to connect to a first wire and the fastener portion has a second terminal configured to connect to a second wire. The electrical jack fastener is insertable into the structural support at any position along the first conductive surface to engage the fastener portion with the second conductive layer and the head with the first conductive layer to provide electrical power to the electrical jack fastener.

The kit can include a plurality of electrical jack fasteners. At least one of the plurality of electrical jack fastener has a first wire connected to the first terminal and a second wire connected to the second terminal, and the first and second wires terminate with and are electrically connected to an electric outlet configured to receive a plug of an electrical light fixture. The first wire and the second wire can be parallel wires or coaxial wires.

### BRIEF DESCRIPTION OF THE DRAWINGS

A better understanding of the features, advantages and principles of the present disclosure will be obtained by reference to the following detailed description that sets forth illustrative embodiments, examples of which are additionally illustrated in the accompanying drawings. In the drawings, like reference numbers indicate identical or functionally similar elements.

FIG. 1 is a side perspective view of a structural support that is flat wiring for a class 2 or class 3 circuit.

FIG. 2 is a longitudinal cross-section through an electrical jack fastener when installed in the structural support of FIG. 1.

FIG. 3 is a bottom perspective view photograph of an embodiment of an electrical jack fastener, which has wiring operatively connected thereto and terminating with an electric outlet, next to a dime as a size reference.

FIG. 4 is a side view photograph of the electrical jack fastener of FIG. 3.

FIG. 5A is a transverse cross-sectional right end view of the structural support of FIG. 1.

FIG. 5B is a transverse cross-sectional view of another embodiment of a structural support that is flat wiring for a class 2 or class 3 circuit.

FIG. 6 depicts one embodiment of the structural support fastened to a substrate to form a first assembly.

FIG. 7 depicts a second embodiment of the structural support fastened to a substrate and covered by a building material to form a second assembly.

FIG. 8 is an image of a drop ceiling having a structural support that is flat wiring for a class 2 or class 3 circuit as one of the drop ceiling panels.

FIG. 9 is a cross-sectional view of the drop ceiling system along line 9-9 of FIG. 8.

FIG. 10 is a cross-sectional view of a third embodiment of the structural support fastened to a plurality of rafters to form a third assembly.

FIG. 11 depicts a structural support assembly having electrical leads for connection to a low voltage power source.

FIG. 12 is a cross-sectional view along line 12-12 in FIG. 11.

FIG. 13 depicts a side view of an embodiment of the structural support coupled to a substrate and to electrical leads of a power supply.

FIG. 14 is a side perspective view of an electrical jack fastener compatible with the structural support.

FIG. 15 is an exploded, partial cut-away, bottom perspective view of the electrical jack fastener of FIG. 14.

FIG. 16 is an exploded, side perspective view of the electrical jack fastener of FIG. 14.

FIG. 17 is a side perspective view of an alternate embodiment of the electrical jack fastener, which has a canopy as the head that includes a plurality of electrical ports.

### DETAILED DESCRIPTION

The following detailed description provides a better understanding of the features and advantages of the inventions described in the present disclosure in accordance with the embodiments disclosed herein. Although the detailed description includes many specific embodiments, these are provided by way of example only and should not be construed as limiting the scope of the inventions disclosed herein.

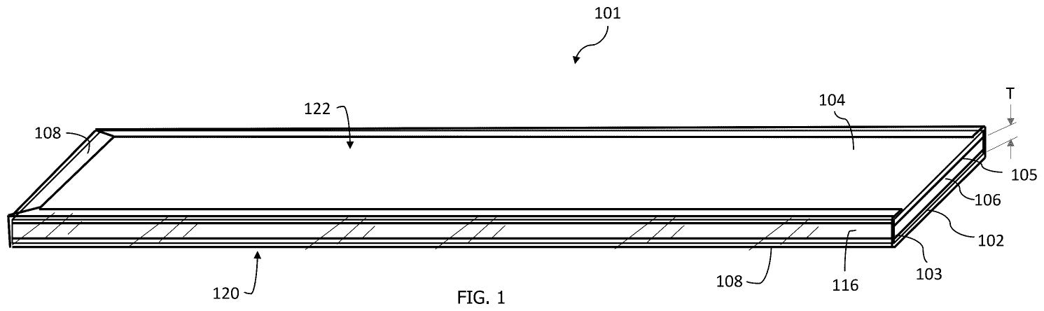

Referring to FIGS. 1-4, a wiring system 100 for light fixtures or other electrical devices that utilize a class 2 or class 3 power supply is disclosed. The wiring system 100 has a structural support 101 that is configured as flat wiring that can support a plurality of light fixtures and/or electrical devices, each individually not exceeding 30 pounds, and has an electrical jack fastener 150 insertable into the structural support 101 at any position along the available conductive surface 120 to engage operatively with the flat wiring thereof. The structural support 101 may be referred to herein in the alternative as a “power board.” The structural support 101 has a first conductive layer 102 opposite a second conductive layer 104 with an insulating layer 106 juxtaposed therebetween and insulating the first conductive layer 102 from the second conductive layer 104. The insulating layer 106 has a thickness (T). The first and second conductive layers 102, 104 are configured to connect to a class 2 or a class 3 power supply to define a circuit. The figures illustrate the first conductive layer 102 as being connected to a negative terminal of the power supply 122 and the second conductive layer 104 as being connected to the positive terminal of the power supply 122, but the invention is not limited thereto. In another embodiment, the opposite configuration may be possible.

The structural support 101 can have a first adhesive layer 103 between the insulating layer 106 and the first conductive layer 102 and a second adhesive layer 105 between the insulating layer 106 and the second conductive layer 104. The adhesive may be a contact adhesive, curable adhesive, reactive adhesive or hot melt adhesive so as to establish a robust mechanical connection between the components. Chemical bonding may also be used instead of or in addition to the adhesive layers. In other embodiments, the insulative layer 106 may be mechanically coupled to the first conductive layer 102 and the second conductive layer 104 by mechanical means including, but not limited to, geometric interference of the components, and fasteners. These mechanical means can be used instead of or in addition to the adhesive layers.

The structural support 101 can also have an insulating film or insulating tape 108 applied to cover at least the first conductive layer 102 and the side(s) 116 of the structural support. As seen in FIG. 1, the first and second conductive layers 102, 104 respectively define first and second major conductive surfaces 120, 122. The sides 116 extend from the first major conductive surface 120 to the second major conductive surface 122 and are typically perpendicular thereto, but the support structure is not limited to such a structure.

In some embodiments, the insulative layer 106 may be mechanically coupled to the first conductive layer and the second conductive layer by mechanical means, including but not limited to, geometric interference of the components, fasteners, such as discrete fasteners, or adhesives. The adhesive may be a contact adhesive, curable adhesive, reactive adhesive, or hot melt adhesive so as to establish a robust mechanical connection between the components.

The embodiment shown in FIG. 1, is a thin elongate structural support, which can be made in board lengths and widths that align with standard building construction materials, such as 2×4s, plywood sheets, etc. or lengths and widths slightly smaller than standard building construction materials. In one embodiment, the structural support has a width in a range of 1 inch to 24 inches, more preferably in a range of 2 inches to 12 inches, even more preferably in a arrange of 2.5 inches to 6 inches. In any of these embodiments, the support structure has a thickness that is one inch or less, more preferably less than 0.5 inch, and even more preferably less than 0.25 inches. In one embodiment, the thickness of the support structure is in a range of 2/16 inch to 4/16 inch. In any of these embodiments, the length of the structural support can be in a range of 2 inches to 8 feet. In one embodiment, the structural support is a square panel, which may be for example purposes only: 1 foot by 1 foot, 2 feet by 2 feet, 4 feet by 4 feet, etc. In one embodiment, the structural support is available as a 4 foot by 8 foot sheet, which like most construction building materials can be cut to a desired size for the application intended by the user. After being cut, the insulating film or insulating tape 108 can be applied to cover at least the first conductive layer 102 and the side(s) 116 of the structural support. In another embodiment, the structural support may be a sheet that is larger than a 4×8 ft² that is cut to desired sizes. One example of a structural support is ALUCOBOND® PLUS aluminum composite panel which consists of two sheets of smooth 0.020″ aluminum thermo-bonded to a solid, fire retardant core, available from 3A Composites USA Inc., Davidson, North Carolina. This aluminum composite panel has a rigidity equivalent to a ⅛ inch thick plate of aluminum.

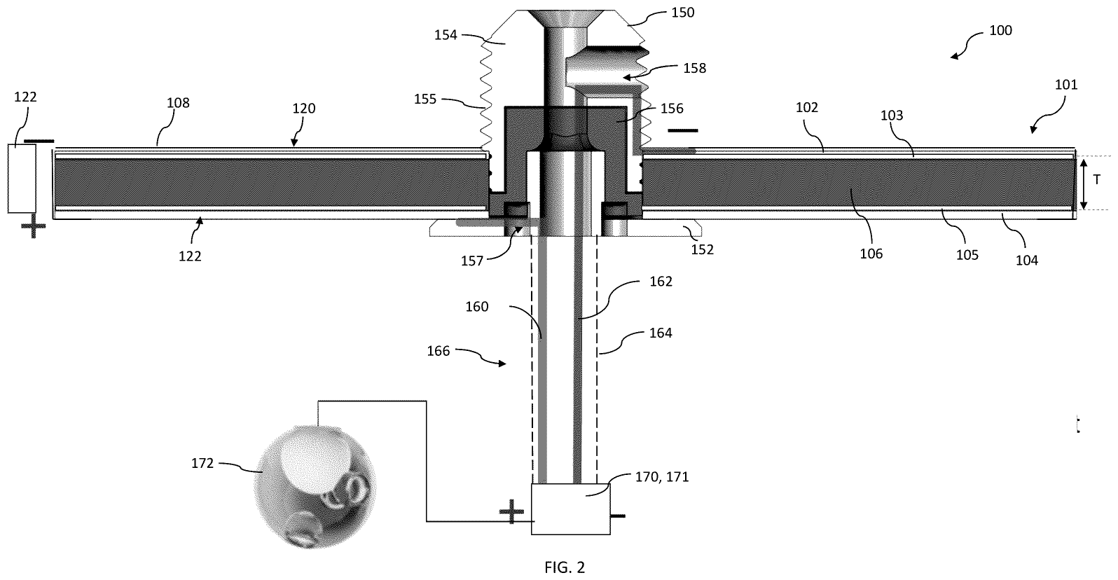

Referring now to FIG. 2, the electrical jack fastener 150 is shown inserted into the structural support 101 of FIG. 1. The electrical jack fastener 150 has a head 152 of conductive material electrically insulated from a fastener portion 154 of conductive material by an insulator insert 156 that is connected to both the head 152 and the fastener portion 154 for movement collectively as a unit. The head 152 includes a first terminal 157 configured to connect to a first wire 160 and the fastener portion 154 includes a second terminal 158 configured to connect to a second wire 162. When the electrical jack fastener 150 is inserted in the structural support 101 the head 152 engages the first conductive surface 120 and the fastener portion 154 engages the second conductive layer 102 to provide electrical power to the electrical jack fastener 150, and hence to an electrical device 170 or, in another embodiment, to an electrical connector 171 configured to receive a plug of an electrical device. In one embodiment, an electrical light fixture or lamp 172 is operatively connected to the electrical jack fastener 150 inserted into the structural support 101. The first wire 160 and second wire 162 can be parallel wires or coaxial wires.

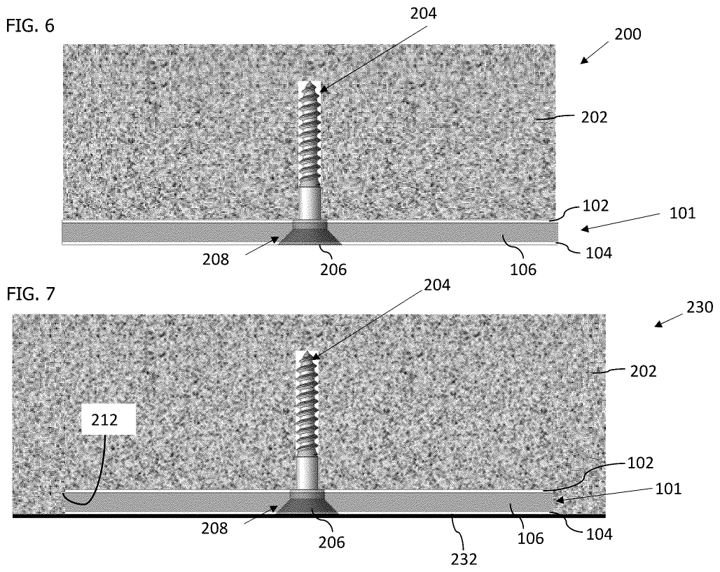

In FIG. 2, the electrical jack connector 150 is screwed into the power board 101 via threading 155. As shown, the electrical jack connector may extend beyond the power board 100 and may further screw and mechanically couple into a substrate 202, such as those shown in FIGS. 6-10, to which the structural support 101 is attached.

The structural support 101 is configured to receive a plurality of electrical jack fasteners 150 along the length and/or width thereof each of which can support and provided electrical connects to an electrical connector and/or electrical device 170, 171. This system 100 provides an installer of electrical devices, such as light fixtures, the flexibility to install a plurality of light fixtures 172, for example, as a group, which can be in an artistic arrangement, without the need to run wiring to each fixture individually. The installer merely inserts each electrical jack fastener 150 into the structural support 101 to an operational depth to make electrical contact with the two conducting layers 102, 104. The structural support 101 also provided the installer the freedom to insert an electrical jack fastener at any position in the second major conductive surface 122, i.e., the installer does not have to install an electrical box in the wall or ceiling or floor against a rafter, joist, or stud. The power board or structural support 101 can provide structural support for the electrical device, such as a light fixture, in one or more orientations, such as allowing it to be suspended from a ceiling, mounted on a wall, or supported from below when the board is secured to a floor or other structure, or in a combination of these configurations.

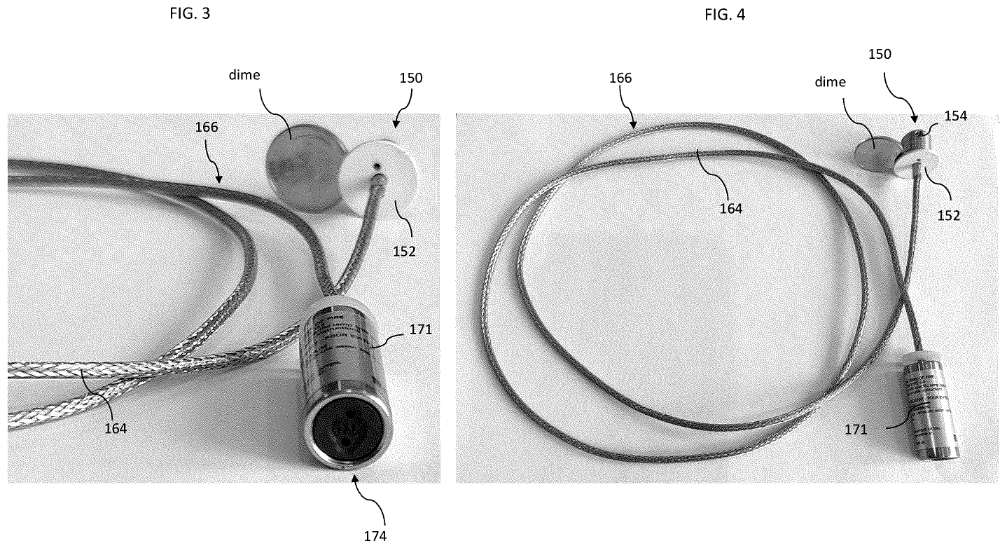

Turning to FIGS. 2-4, the first and second wires 160, 162 can be housed together inside a casing 164 to define a wire 166. As shown in the embodiment of FIGS. 3 and 4, the wire 166 is operatively connected to the electrical jack fastener 150 and terminates with an electrical connector 171 that defines an electrical outlet 174, which can be configured to receive a plug of an electrical device, such as a light fixture 172 (shown in FIG. 2).

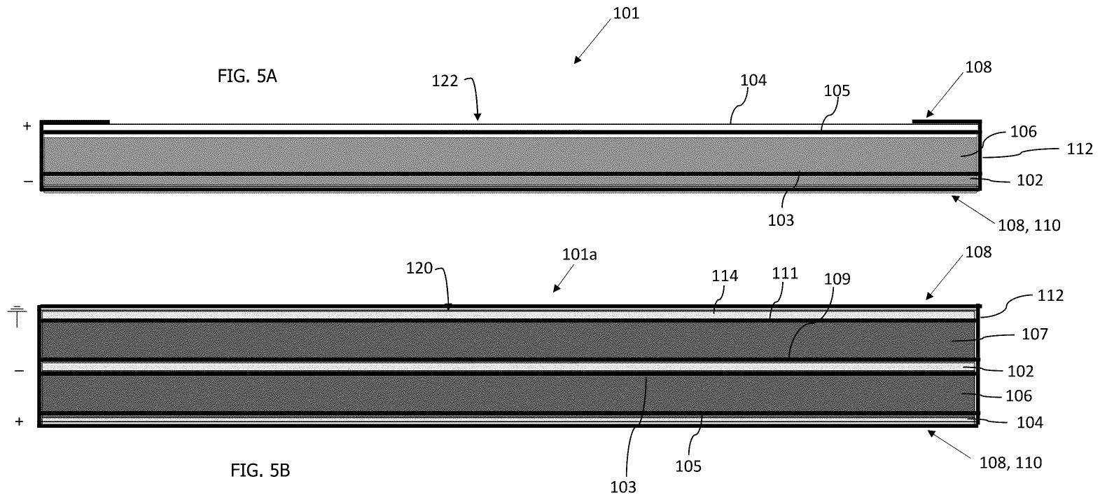

Turning now to FIGS. 5A and 5B, power boards 101, 101a each contain two or three conductive layers, respectively, separated by insulators to form a composite, sheet-like support structure. With reference to FIG. 5A, which is a transverse cross-sectional view of the structural support 101 of FIG. 1. The structural support 101 includes in order from top to bottom, relative to its orientation on the page, an insulating film, insulating tape, or insulating coating 108 partially wrapped onto the second major conductive surface 122, which is defined by the second conductive layer 104, an adhesive layer 105, an insulating layer 106, another adhesive layer 103, the first conductive layer 102, and a bottom insulting layer 110, which can be part of the insulating film, insulating tape, or insulating coating 108 or separate and distinct therefrom. The insulating film, insulating tape, or insulating coating 108 can also form a side insulating layer 112 or the side insulating layer 112 can be separate and distinct therefrom. Typically, the first conductive layer 102 is connected to a positive terminal of the power supply and the second conductive layer 104 is connected to a negative terminal of the power supply.

With reference to FIG. 5B, which is a transverse cross-sectional view of an alternate embodiment of a structural support 101a. The structural support 101a includes in order from top to bottom, relative to its orientation on the page, an insulating tape 108 fully covering the first major conductive surface 120, which is defined by a third conductive layer 114, a fourth adhesive layer 111, a second insulating layer 107, a third adhesive layer 109, the first conductive layer 102, a first adhesive layer 103, a first insulating layer 106, a second adhesive layer 105, the second conductive layer 104, and a bottom insulting layer 110, which can be part of the insulating tape 108 or separate and distinct therefrom. The insulating tape 108 can also form a side insulating layer 112 or the side insulating layer 112 can be separate and distinct therefrom. As shown in FIG. 5B, the third conducting layer 114 can be connected to ground or neutral, while the first conductive layer 102 is connected to a negative terminal of the power supply, and the second conductive layer 104 is connected to a positive terminal of the power supply.

Any of the conductive layers disclosed herein, i.e., a first, a second, a third, a fourth, etc., can be made of any conductive material. Common conductive materials include metals and/or metal alloys. In some embodiments, any of the conductive layers can include aluminum and/or copper metal or metal alloys thereof. The metal or metal alloy and its layer thickness can be selected to meet specific requirements of the system, including voltage, structural needs, and electrical resistance.

Any of the insulating layers 106 can be made of any material that has electrical insulating properties. In some embodiments, the insulative layer may be made of wood, a polymer, drywall, or other structural materials. In some embodiments, the insulative layers 106, 107 extends to the ends of the first conductive layer 102 and the second conductive layer 104 such that the first conductive layer, the second conductive layer, and the insulative layer are coextensive. In other embodiments, the insulative layers 106, 107 may extend beyond the ends of one or more of the first conductive layer 102 and the second conductive layer 104.

The insulating film, insulating tape, or insulating coating 108, bottom insulating layer, or side insulating layers 112, can be made of high density polyethylene (HDPE), polyethylene (PE), polypropylene (PP), fluoroethylene vinyl ether (FEVE), polyvinylidene difluoride (PVDF), an epoxy resin, or other commercially available materials known to have electrical insulating properties.

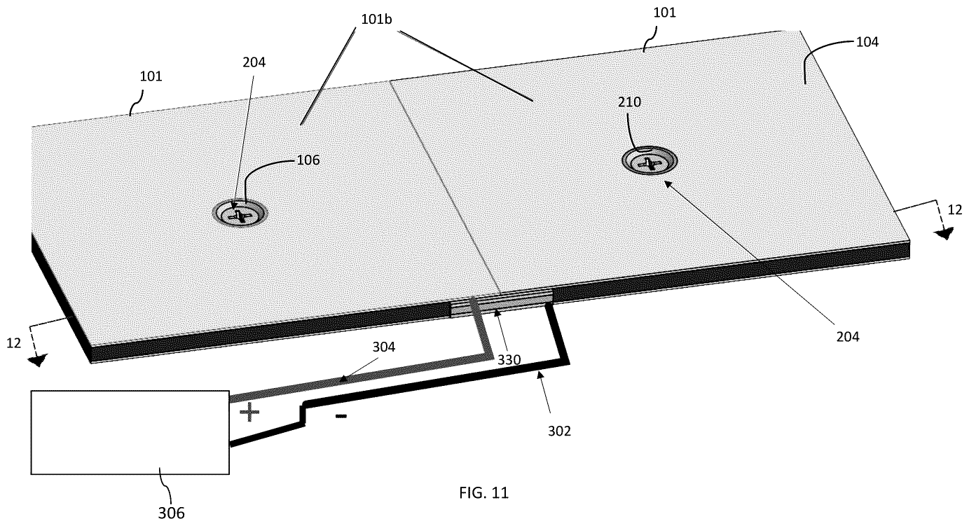

Referring to FIGS. 6-10, examples are provided of various ways to mount the structural support 101 to building materials, such as ceilings and walls. Turning now to FIG. 6, the structural support 101 (power board) is coupled to a substrate 202 to form an assembly 200. The substrate 202 can be a stud, rafter, drywall, Masonite, cement board, plywood, subflooring, cement, or any other building material used to form a floor, or ceiling, and the structural support 101 is mounted directly against the substrate 202. In assembly 200, the power board 101 is mechanically coupled to the substrate 202 using fastener 204. The fastener 204 can be a screw, bolt, nail, or other mechanical fastener. To provide the fastener 204 with a non-conductive state, the fastener 204 can be recessed into a countersink void 210 (best seen in FIG. 11) having been formed by removal of the second conductive layer 104, such that the fastener engages the insulating layer 106 and the first conductive layer 102 only. In another embodiment, an insulative layer 208 may be located between the head 206 of the fastener 204 or other portion of the fastener 206 that would otherwise be in contact with either of the conductive layers 102, 104 of the power board 101. In some embodiments, the fastener 204 can be made of non-conductive material(s). Looking now to FIG. 7, in assembly 230, rather than being mounted to a surface of the substrate 202, the structural support 101 is seated in a recess 212 within the substrate 202 such that the structural support 101 can be covered with a layer of building material 232. The building material 232 can be paint, drywall mud, or other material that defines a finished surface. The structural support 101 can be mechanically coupled to the substrate 202 as described above with respect to FIG. 6. Assembly 230 can provide an aesthetically pleasing finished surface since the structural support 101 will not be visible to the naked eye, e.g., the layer of building material 232 can smooth out any irregularities or imperfections in the surface of the component and create a uniform appearance.

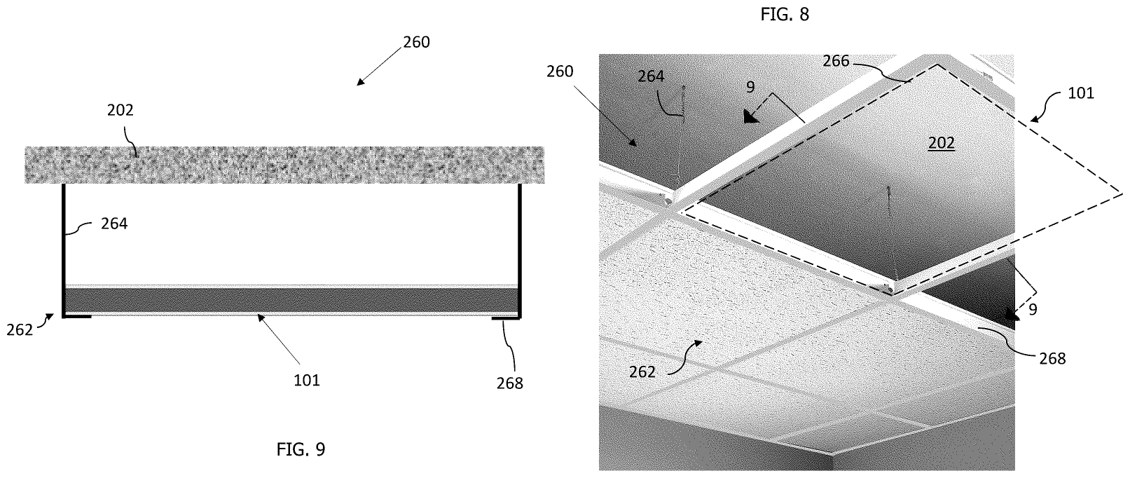

Turning now to FIGS. 8 and 9, assembly 260 is shown. The assembly 260 includes a power board 101 as a panel 266 of a suspended ceiling 262, such as in a commercial, residential, or industrial suspended or “drop” ceiling. One or more couplings 264, which may be hangers, suspend the power board 101 from the ceiling 202 via grid 268. The hangers 264 may be mechanically coupled to the grid 268, such as with fasteners. The grid 268 typically defines a plurality of openings, which each are of a predefined shaped having an inward extending flange surface on which an edge of the power board 101 rests.

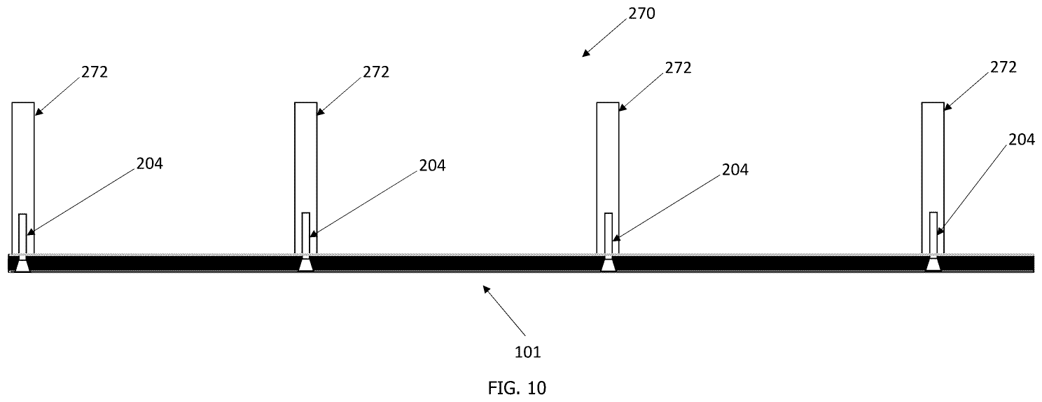

FIG. 10 depicts an assembly 270. The assembly 270 includes a power board 101 that acts as a structural and, optionally fire inhibiting, component of a wall, ceiling, or floor. The power board 101 may be affixed directly to structural members 272, which may be studs, joists, rafters, etc. via fasteners 204 which may have the same features of fastener 204 discussed above.

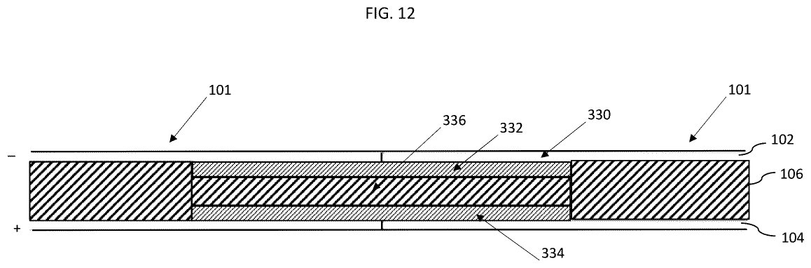

Turning now to FIGS. 11 and 12, a power board assembly 101b is shown, which has two power boards 101 connected to one another, such as by an end-to-end connection or a side-to-side connection. A biscuit 330 is shown as mechanically and electrically coupling the two power boards 101 together. The biscuit 330 is also providing the electrical connection to wires 302, 304 that connect the assembly to a power supply 306. The biscuit 330 may be inserted into the insulative layer at the interface of the two power boards 101. The biscuit 330, as more clearly seen in FIG. 12, has a first conductive layer 332 which is electrically and mechanically coupled to the first conductive layer 102 of the power board 101. The first conductive layer 332 may be coupled to a wire or other electrical conductor that is also connected to a power source or ground. The biscuit 330 includes a second conductive layer 334 which is electrically and mechanically coupled to the second conductive layer 104 of the power boards 101 and an insulating layer 336 separating the second conductive layer 334 form the first conductive layer 332. The second conductive layer 334 may be coupled to a wire or other electrical conductor that is also connected to a power source or ground. If the power board has the construction shown in FIG. 5B, the biscuit 330 will likewise have similar layering of conductive layers and insulating layers to connect the two power boards 101 together.

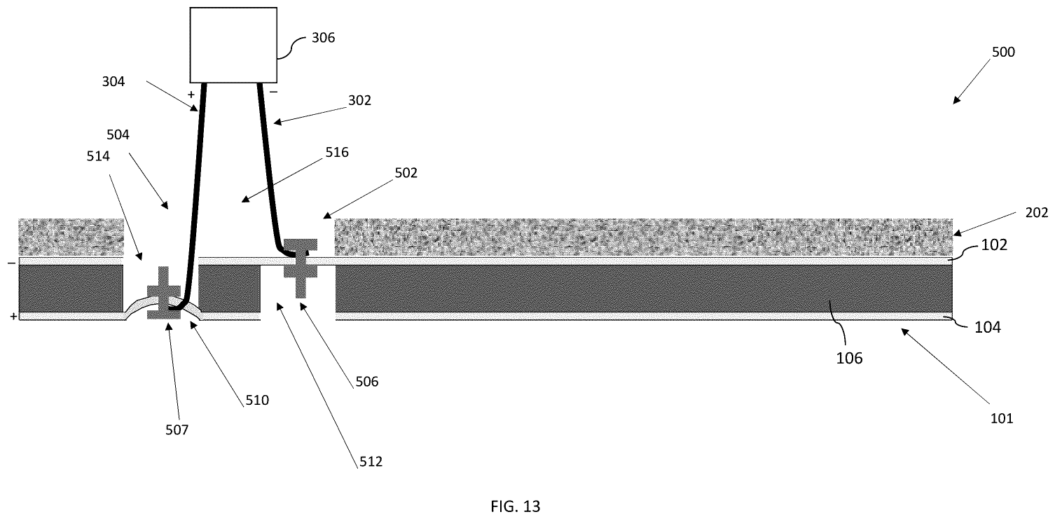

Turning now to FIG. 13, the assembly 500 depicts power leads (wires 302, 304) connected to terminals 506, 507 in operative electrical connection to the first and second conductive layers, respectively, of a structural support 101, which is coupled to a substrate 202. The conductive layers of the power board 101 may be connected to a power source 306 and/or indoor ground using wires 302, 304 coupled to screws and/or screw terminals 506, 507 on the conductive layers of the power board 101. An aperture 516 may be formed in the substrate 202 through which the conductive wire 302, 304 pass to access terminals 506, 507. An aperture 512 may be formed through the second conductive layer 104 of the power board 101 to provide access to one side of the terminal 506 while the aperture 516 provides access to the other side of the terminal 506. The terminal 506 as depicted is coupled to the negative terminal of the power source 306 via wire 302.

An aperture 514 may be formed through the first conductive layer 102 of the power board 101 and through the insulating layer 106 via aperture 516 to provide access to a first side of the terminal 507. The second conductive layer 104 may include a recess or countersink void 510 in the second major surface 122 thereof to seat a portion of the terminal 507 therein, thereby maintaining a general smooth continuous second major surface 122 for the structural support 101. The recess 510 may be filled in with a suitable building material in order to provide a flush clean look to the installation. Similarly, aperture 512 may be filled in with a suitable building material to provide a clean look to the installation. The terminal 507 as depicted is coupled to the positive terminal of the power source 306 via wire 304.

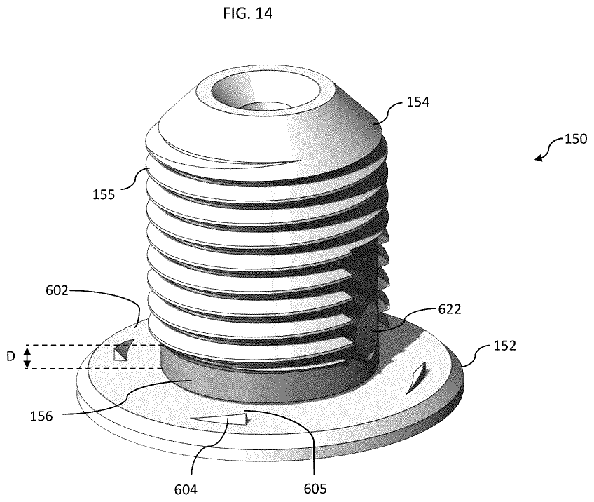

Referring to FIGS. 14-16, enlarged and exploded views of the electrical jack connector 150 are provided. The electrical jack connector 150 has a head 152 made of electrically conductive material, a fastener portion 154 made of electrically conductive material, and an insulator insert 156 seated between the head 152 and the fastener portion 154 to space them apart from one another a distance (D). The fastener portion 154 can have threading 155, rendering the jack to look similar to a screw. The head portion 152 has a plurality of teeth 604 protruding from a back surface 602 thereof. The teeth 604 are oriented to bite into the second conductive layer 104 (into the second major surface 122 thereof) and are shaped as an arcuate wedge. In one embodiment, an apex 605 of each arcuate wedge is oriented to be the leading surface of each tooth 604 as the jack 150 is threaded into the structural support 101.

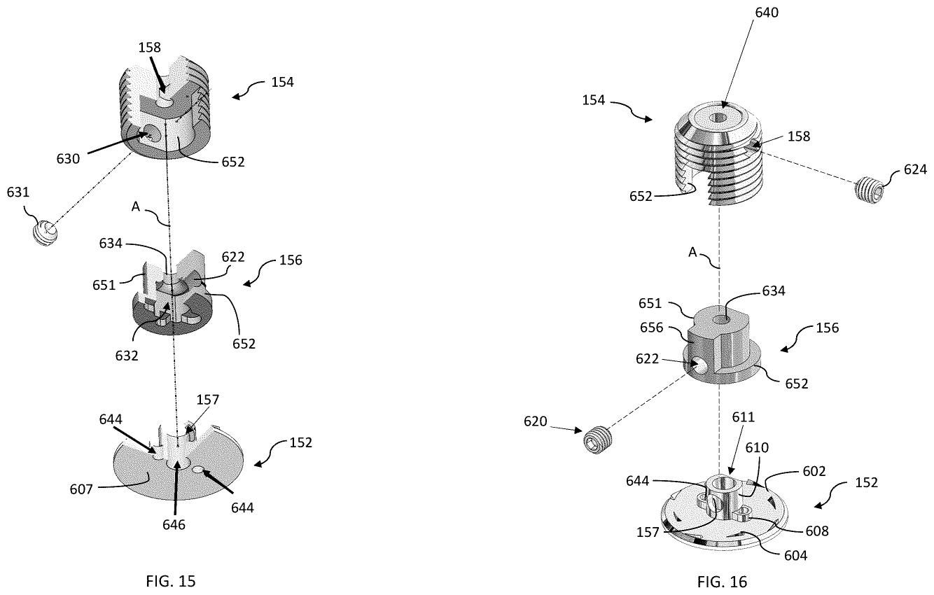

As best seen in FIGS. 15 and 16, the head 152 has one or more apertures 644 in the front surface 607 thereof sized and arranged to receive a tool to facilitate the insertion of the electrical jack connector 150 into a structural support 101. When the fastener portion 154 is threaded, the tool may be a type of screwdriver. In one embodiment, there are two apertures 644 arranged in a line with the center of the electrical jack connector 150 to receive a snake eyes screwdriver. The one or more apertures 644 can be a through bores and the back surface 602 can include a flange 608 protruding rearward for each one of the apertures 644 that defines a portion of each through bore. The head 152 also has a rearward protruding post 610 which defines a first terminal 157. The first terminal 157 may be a through bore oriented perpendicular to the central longitudinal axis (A) of the jack 150. The head 152 also has an aperture 646 configured to receive wires for connections to the first and second terminals 157, 158 of the head 152 and fastener portion 154, respectively.

The insulator insert 156 can be shaped as a post 651 having a collar or flange 652 at the head end thereof and oriented radially outward. The insulator insert 156 electrically insulates and/or isolates the head 152 from the fastener portion 154. As such, the cavity 632 is shaped to mate with the post 610. The insulator insert 156 defines cavity 632 configured to receive the post 610 of the head 152. In some embodiments, the post 610 and cavity 632 are asymmetrical with respect to the longitudinal axis (A) of the jack 150. For example, the shaft and cavity may each have a rounded portion and a flat portion 611. The asymmetry allows the parts of the assembled jack connector to resist separate rotations, such that they rotate together. In another embodiment, the post 610 of the head and the cavity 632 of the insulator insert 156 have a key-keyway connection or a keyway-key connection, for rotation together and for registered alignment of other features, such as aperture 622 to the first terminal 157 of the head 152. Aperture 622 is configured to receive a coupling 620, such as a screw, including a threaded set screw as shown in FIG. 16. The aperture 622 is oriented for alignment with the first terminal 157 of the head 152; thus, the threaded set screw 620 can be inserted into the aperture 622 and aperture 642 in the head 152 to connect and hold a wire in electrical communication with the head 152. The shaft of the screw may be arranged such that it engages simultaneously with both the aperture 622 of the insulator insert 156 and the first terminal 157 of the head 152 to also couple the head 152 with the insulator insert 156.

Still referring to FIGS. 15 and 16, the fastener portion 154 is shown as having threading 155. The threads 155 of the fastener portion 154 mechanically and electrically couple the electrical jack connector to the first conductive layer 102 of the power board 101 and mechanically couple to the insulative layer 106 of the power board 101. In this way, the electrical jack connector 150 provides both electrical and structural connection to the electrical power board 101. The fastener portion 154 has an aperture 630 for receiving a coupling, such as a screw, including a threaded set screw 631. The threaded set screw 631 may be inserted into the aperture 630 and secured against the post 651 of the insulator insert 156 to couple the fastener portion 154 to the insulator insert 156. Wiring can enter the jack 150 through aperture 646 of the head 152, then split, so that a first wire connects to the first terminal 157 and a second wire extends through cavity 632 and through aperture 634 in the insulator insert 156 and the second wire then connects to the second terminal 158 in the fastener portion 154 and can be secured therein by a fastener 624, such as a screw, including a threaded set screw 624.

The threaded portion 154 defines a cavity 652 shaped to receive and mate with the post 651 of the insulator insert 156. The threaded portion 154 can define a slot 654 through the body thereof, which is open at the end facing the head 152. The insulator insert 156 can include a protrusion 656 extending radially outward on the post 651, which is shaped to slide into the slot 654 when the two are mated together. In some embodiments, the post 651 and cavity 652 may be asymmetrical with respect to the longitudinal or rotational axis of the jack connector. For example, the shaft and cavity may each have a rounded portion and a flat portion. The asymmetry allows the parts of the assembled jack 150 to resist separate rotations, such that they rotate together.

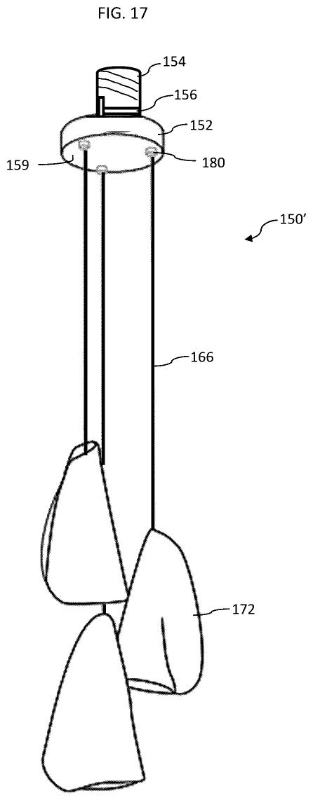

Turning now to FIG. 17, one embodiment of the electrical jack fastener 150′ has a canopy 159 as the head 152 thereof attached to the threaded portion 154 in the same manner as described above with the insulator insert 156 therebetween. The canopy 159 includes one or more electrical ports 180. The embodiment of FIG. 17 has a plurality of electrical ports 180, specifically three electrical ports, but canopies can have any number thereof so long as the weight limitations of the support structure is not exceeded. Each of the electrical ports 180 can have a wire 166 in operative electrical communication with the head 152 and fastener portion 154 for operative connection to the support structure 101 of FIG. 1 as described herein. The wires 166 can be coaxial wires or have parallel wires inside a casing 164, see FIG. 3. And each wire 166 can be electrically connected to an electrical device, such as a light fixture 172. As noted herein, the electrical system provided by the structural support 101 is for class 2 and class 3 electrical devices.

Although the drawings generally depict a single electrical jack connector 150 and a single structural support 101, any of the assemblies disclosed herein can include multiple electrical jack connectors 150 and multiple structural support 101 connected to each other in order to provide many different lighting and electrical options.

The configuration offers an innovative solution that provides connection points similar to traditional lighting canopies, but with greater flexibility, improved aesthetic appeal, and artistic design.

The processes and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed. Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step. A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and shall have the same meaning as the word “comprising.” It will be understood that although the terms “first,” “second,” “third,” etc. may be used herein to describe various layers, elements, components, regions, or sections without referring to any particular order or sequence of events. These terms are merely used to distinguish one layer, element, component, region or section from another layer, element, component, region, or section. A first layer, element, component, region, or section as described herein could be referred to as a second layer, element, component, region, or section without departing from the teachings of the present disclosure. As used herein, the term “or” is used inclusively to refer items in the alternative and in combination.

Embodiments of the present disclosure have been shown and described as set forth herein and are provided by way of example only. One of ordinary skill in the art will recognize numerous adaptations, changes, variations, and substitutions without departing from the scope of the present disclosure. Several alternatives and combinations of the embodiments disclosed herein may be utilized without departing from the scope of the present disclosure and the inventions disclosed herein. Therefore, the scope of the presently disclosed inventions shall be defined solely by the scope of the appended claims and the equivalents thereof.

What is claimed is:

1. A wiring system for light fixtures comprising:
a structural support comprising a first conductive layer opposite a second conductive layer with an insulating layer juxtaposed therebetween and insulating the first conductive layer from the second conductive layer, wherein the first and second conductive layers are configured to connect to a class 2 or a class 3 power supply to define a circuit and the insulating layer has a thickness (T); and
an electrical jack fastener comprising a head of conductive material electrically insulated from a fastener portion of conductive material by an insulator insert connected to both the head and the fastener portion for movement collectively as a unit; wherein the head comprises a first terminal configured to connect to a first wire and the fastener portion comprises a second terminal configured to connect to a second wire;
wherein the electrical jack fastener is insertable into the structural support at any position along the first conductive surface to engage the fastener portion with the second conductive layer and the head with the first conductive layer to provide electrical power to the electrical jack fastener.

2. The wiring system of claim 1, wherein the electrical jack fastener comprises the first wire connected to the first terminal and the second wire connected to the second terminal.

3. The wiring system of claim 1, wherein the first wire and the second wire can be parallel wires or coaxial wires.

4. The wiring system of claim 2, wherein the first and second wires terminate with an electric outlet configured to receive a plug of an electrical light fixture.

5. The wiring system of claim 3, further comprising an electrical light fixture plugged into the plug connector.

6. The wiring system of claim 1, wherein the fastener portion of the electrical jack fastener is threaded.

7. The wiring system of claim 1, wherein the head portion of the electrical jack fastener has a plurality of teeth protruding from a back surface thereof which are oriented to bite into the first conductive layer.

8. The wiring system of claim 1, wherein the structural support has a first adhesive layer between the insulating layer and the first conductive layer and a second adhesive layer between the insulating layer and the second conductive layer.

9. The wiring system of claim 8, wherein the structural support has an insulating film or insulating tape applied to cover at least the second conductive layer and the sides of the structural support.

10. The wiring system of claim 1, wherein the structural support comprises a second insulating layer separating the first conducting layer from a third conducting layer, and the third conducting layer is configured to connect to ground.

11. The wiring system of claim 1, wherein the head of the electrical jack fastener comprises a canopy define one or more electrical ports.

12. A kit comprising:
a structural support comprising a first conductive layer opposite a second conductive layer with an insulating layer juxtaposed therebetween and insulating the first conductive layer from the second conductive layer, wherein the first and second conductive layers are configured to connect to a class 2 or a class 3 power supply to define a circuit and the insulating layer has a thickness (T); and
an electrical jack fastener comprising a head of conductive material electrically insulated from a fastener portion of conductive material by an insulator insert connected to both the head and the fastener portion for movement collectively as a unit; wherein the head comprises a first terminal configured to connect to a first wire and the fastener portion comprises a second terminal configured to connect to a second wire;
wherein the electrical jack fastener is insertable into the structural support at any position along the first conductive surface to engage the fastener portion with the second conductive layer and the head with the first conductive layer to provide electrical power to the electrical jack fastener.

13. The kit of claim 12, wherein the electrical jack fastener comprises the first wire connected to the first terminal and the second wire connected to the second terminal, and the first and second wires terminate with and are electrically connected to an electric outlet configured to receive a plug of an electrical light fixture.

14. The kit of claim 13, wherein the first wire and the second wire can be parallel wires or coaxial wires.

15. The kit of claim 12, further comprising a plurality of electrical jack fasteners.

16. The kit of claim 14, wherein at least one of the plurality of electrical jack fastener comprises the first wire connected to the first terminal and the second wire connected to the second terminal, and the first and second wires terminate with and are electrically connected to an electric outlet configured to receive a plug of an electrical light fixture.

17. The kit of claim 16, wherein the first wire and the second wire can be parallel wires or coaxial wires.

18. The kit of claim 12, wherein the head of the electrical jack fastener comprises a canopy define one or more electrical ports.
